(19) United States
(12) Patent Application Publication
(10) Pub. No.: US 2009/0198539 A1
(43) Pub. Date: Aug. 6, 2009

(54) Onscreen takeoff incorporating typical areas system, method and computer product

(76) Inventor: Leonard Buzz, Spring, TX (US)

Correspondence Address: Michael T. Perkins, 902 McPhaul st, Austin, TX, 78758, US

(21) Appl. No.: 12/154,195

(22) Filed: May 21, 2008

Related U.S. Application Data
(60) Provisional application No. 61/063,768, filed on Feb. 6, 2008.

(51) Int. Cl. G06Q 10/00; G06F 17/50

(52) U.S. Cl. 705/7; 703/1

(57) ABSTRACT

A system, method, and computer product for taking installation information off areas of digital plans for estimating and evaluating with predetermined material, labor rates, and costs. The system incorporates typical areas and typical groups for repeating objects in applications such as office buildings and hotels. The system automatically sums individual inputs and facilitates sharing, bidding, and evaluation of areas. Drawings are color coded to communicate to the operator what status is. Areas and conditions can be duplicated, manipulated, copied, pasted, grouped, reassigned, and adjusted to reuse in other parts or plans.

### RELATED APPLICATIONS

Provisional application “Digital percent complete process” No. 60/496,405 filed on Aug. 20, 2003, Patent application “Digital percent complete process” Ser. No. 10/922,083 filed on Aug. 20, 2004, Provisional application “System and method for digital production control” filed Feb. 6, 2008, Provisional application “System and method for on screen takeoff” filed Feb. 6, 2008,

### BACKGROUND

1. Technical Field of Invention 705/32

This invention relates to time and material accounting and more particularly to such an accounting system with creating takeoffs from digital and paper plans for material, labor, scheduling, and billing purposes with interface compatibility to bidding and tracking software.

2. Background of the Invention

Bidding of construction projects has evolved from very early versions of guessing and hand measuring to determine estimates for bidding. Some contractors through natural ability and perseverance were able to accurately measure drawings together with actual sites and guess at costing for implementing of the drawings while others were not. The ones that persevered and guessed well were possibly successful and the others went into other lines of work. Today professional construction projects are based on bids submitted by bid that contain a complete drawing plan with estimates of labor, time, materials, and a sequencing plan that allows equipment and material to be delivered and utilized. There is usually stiff competition for projects and the successful bidder must be very accurate and expect no tolerance from a contracting administrator (not paid) for bad guesses or miscalculations. Accuracy is especially critical on jobs that involve repeating areas, multiple floors, and wings were errors, when made are repeated and multiplied. Humans have always looked for ways to reduce repetition in their efforts with an eye towards improving productivity and reducing boredom. The term “cut and Paste” has derived from a historical practice in manuscript editing whereby editors would physically cut portions of text and affix them with paste to a different section saving editing time. With the advent of photocopiers new and innovative ways of manipulating text were employed further saving effort and time. In the mid-seventies a researcher (L. G. Tesler) at the Xerox Palo Alto Research Center implemented a computer metaphor that electronically implemented a computer interface version of “cut and paste” with simple keystroke combinations. This technique migrated into the widely used computer and personal computer operating systems. Typically text as well as graphical and information transferring currently greatly reduces repetitive operator inputs. The standard “cut and paste” functionality involved transfer of the properties, information, and representations but would not adjust to changes involving multilayer and scale.

These legacy systems improve productivity but fail to fully improve the productivity of the operator for large complex building plans with repetition of objects. In many plans for high-rise, multi-floor, or multi-building complexes many objects (walls, ceilings, rooms, even entire floors are repeated. However, due to complexities in implementation (graphical, information, data base content, and scale differences) no system or method to date as offered the ability to capture and reuse an information rich takeoff representation through an operation as simple as any computer-based editing operation.

In U.S. Pat. No. 5,032,907 by Isnardi titled “Video panning system for widescreen television”. Isnardi discloses a widescreen television system compatible with a lesser aspect ratio standard television system employs a panning operation using a circular-shift method. Isnardi has developed a method for handling manipulation of images but the methodology as disclosed has no digital drawing interface of data base integration capabilities. The combining of Isnardi methods with digital drawing capabilities would not be possible without complete redesign and rewriting of the methods disclosed by Isnardi. Furthermore incorporating additional processing and functionality would not have the necessary interface capabilities (mouse, keyboard, and printer hardware or software drivers). In U.S. Pat. No. 5,189,606 by Burns, et al. titled “Totally integrated construction cost estimating, analysis, and reporting system”. Burns discloses an integrated construction cost generator which may be used to develop costs for construction projects but the overall complexity and breath of Burns system would not be maintainable or sensible for combination with inclusion of typical areas functionality. Inclusion of additional functionality for takeoff costing and estimating would not be part of a system designed to review and monitor construction projects and would be a distraction for operators of Burn's system. In U.S. Pat. No. 6,324,437 by Frankel, et al. titled “System and method for managing the alteration of garments”. Frankel discloses a system and method for managing garment alterations. While Frankel has systems and methods for dealing with specific operational garment alterations adaptations there is no facility for interfacing and manipulating digital drawings and combing with these functions would be difficult and render the system incapable of operating for the original purpose of garment alterations. Inclusion of digital drawing manipulation and interfacing would not be useful for Frankel's system and would reduce the operator's ability to efficiently managing garment alterations. In U.S. Pat. No. 6,324,508 by Finney titled “Automated method for a takeoff estimate of construction drawings”. Finney discloses a method for performing a construction quantity takeoff estimate of a drawing representative of a construction project with voice recognition. While there may be usefulness in implementing voice recognition the critical problem in estimating large projects with repeating objects is not addressed and including these features would demand a complete re-architecture and code rewrite of the Finney system where the vocabulary could grow beyond the value to render the system useless. In U.S. Pat. No. 6,658,387 by Finney titled “Method for indexing an image during an automated takeoff estimate of a construction drawing”. Finney discloses a method for determining construction quantity takeoff information of a drawing representative of a construction project. Here Finney has furthered his manipulation of construction estimating and monitoring but still does not directly interface with digital drawings leaving a gap in project operations and making work for the operators he is trying to relieve of tasks. Inclusion of interfacing and manipulation of digital drawings would not be compatible with the methods of indexing as disclosed by Finney and confusion would reduce operator efficiency. In U.S. Pat. No. 7,178,098 by Bauchot et al. titled “Method and system in an electronic spreadsheet for handling user-defined options in a copy/cut-paste operation”, Bauchot discloses an example of a solution comprises defining one or more combinations of options, defining an operation to execute (e.g. copy and paste, or cut and paste), computing the content of each cell. These methods are useful on projects limited to spreadsheets only as there is no digital drawing interface capability and combining such capabilities would demand a re-structure and re-writing of operational code as a digital drawing interface and manipulation display code is considerably larger than Bauchot's code. Inclusion of digital drawing methods would not enhance handling of electronic spreadsheets and would slow operation leading away from the Bauchot disclosed intent. In U.S. Pat. No. 7,254,266 by Cotman et al. titled “Method and apparatus for generating special-purpose image analysis algorithms”, Cotman discloses providing quantitative data about a two or more dimensional image. While Cotman has disclosed an image manipulating method the techniques as disclosed are overly complex for operating with digital construction drawings. The complexity of Cotman would require processing power beyond that which is necessary and available for operator in situ computations.

What is needed is a system that eliminates the manual take off process on digital drawing plans that captures selected images, automatically calculating precise quantities and costs with simple handling of repeated areas. The ability to instantly calculate multiple quantities for each condition with selectable formulas. The ability to create typical takeoff conditions for reuse on similar tasks.

### SUMMARY OF THE INVENTION

A system, method, and computer product for determining takeoff quantity information from areas of digital plans for estimating and evaluating project costs based on predetermined material, labor rates, and costs. Through a computer survey the system automatically sums individual inputs and facilitates sharing, bidding, and evaluation of items and areas from operator drawings on computer screens. Drawing objects are color coded to communicate to the operator what type of object and object status. Areas and conditions can be manipulated, copied, pasted, grouped, reassigned, and adjusted to reuse areas and conditions in other parts of the plan. Takeoff items and objects drawn in a site or project plan can be selected, duplicated, and/or assigned to entirely different assemblies or conditions and automatically placed on any desired page the quantity survey process will automatically adjust any scale differences that may exist between the source plan and the plan the object is to be reassigned.

Typical areas can be designated and reused when plans have repetition. Typical area quantity survey process consists of the following; a specific process of system software quantity survey or takeoff of repeated assemblage of lines, objects, and conditions being collected and stored that speeds the cost estimator or engineers ability to quickly count (quantify) building conditions for large projects that have multiple typical areas both groups of conditions and repeating levels or floors. Additionally, typical areas is suited for a building project that has groups of conditions (Typical Groups) i.e. (a specific arrangement of walls, ceilings, electrical components, finishes or furnishings or any other group of mechanical, electrical or architectural building elements) or (repeating similar floors or levels) that repeat throughout a project. The most common of these are groups of building conditions that repeat throughout the project or a project with multiple repeating identical floors which many times are represented on separate pages and at different scales of measurement on the construction documents. The program control automatically converts scaling of items with different dimensions. The program correlates graphical information and database values. The typical areas quantity survey process allows the user to takeoff or count quantities that occur within a building project using a computer with electronic takeoff software and an image of the building project as a background for tracing to accurately count quantify the construction conditions that exist within a specific group of building conditions. Typical groups are defined as organized takeoffs collected as groups of takeoffs that can easily be pasted in a bid as single object. Typical pages are configured by marking a page as a repeating page and the processor does the takeoff math.

### BRIEF DESCRIPTION OF THE DRAWINGS

FIG. 1 shows a block diagram of an on screen takeoff overall system incorporating typical areas functionality.

FIG. 2 shows an operator interface device for an on screen takeoff system incorporating typical areas functionality.

FIG. 3 shows a program flow for an on screen takeoff system incorporating typical areas functionality.

FIG. 4a shows a graphical screen presentation for an on screen takeoff system incorporating typical areas functionality.

FIG. 4b shows an on screen data sheet presentation for an on screen takeoff system incorporating typical areas functionality.

FIG. 5 shows a section of a screen with a calculation of an object to establish a condition for an on screen takeoff system incorporating typical areas functionality.

FIG. 6 shows a sample data type format for an on screen takeoff system incorporating typical areas functionality in industry standard data format.

FIG. 7 shows an on screen technique for reusing established conditions in an on screen takeoff system incorporating typical areas functionality.

FIG. 8 shows an on screen technique for establishing a typical area condition in an on screen takeoff system incorporating typical areas functionality.

FIG. 9 shows a screen presentation of an image and conditions of a building with repeating floors for a typical area condition in an on screen takeoff system incorporating typical areas functionality.

FIG. 10 shows a screen with a portion of the image and conditions of a building with repeating floors, as in FIG. 9, displayed for designation as a typical group.

FIG. 11 shows a screen with a notice from the system processor instructing the operator on procedures to initiate designation of a typical group function.

FIG. 12 shows a screen with a typical group designated.

FIG. 13 shows a screen with a designated typical group combined into an entire floor.

FIG. 14 shows a data screen with a designated typical group assigned to multiple floors.

FIG. 15a shows a pop up screen with typical page association instructions for operators.

FIG. 15b shows a screen with a typical page banner to inform the operator that grouping and associations have been incorporated.

FIG. 16 shows a screen displaying repeated typical groups on repeated floors.

### DETAILED DESCRIPTION

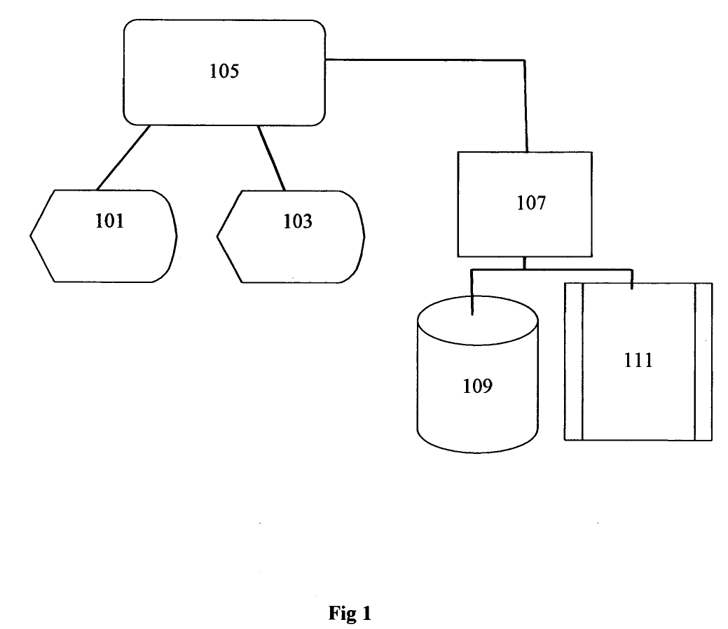

FIG. 1 shows a block diagram of an on screen takeoff overall system incorporating typical areas functionality. The system is typically located in situ at the operator's location but could be anywhere the operator chooses to perform analysis of digital drawing plans through on screen takeoffs. A block 101 represents operator interface such as a screen that could be any type of display screen which may include touch input. A block 103 represents an input device such as a keyboard, voice, mouse, scanner, or other appropriate devices for inputting information into an on screen takeoff system. A block 105 represents a computer interface to an in situ processor 107 for running the on screen takeoff system software. The processor 107 has a storage 109 device where project data, system software, and information are kept in unique addresses and locations within the storage 109 wherein project data information is kept in unique locations, and output device 111 such as a printer or plotter produces reports, images, or documents. Although not shown the system can be connected to network devices such as the internet for data submission, submitting, upgrades, or other remote functions.

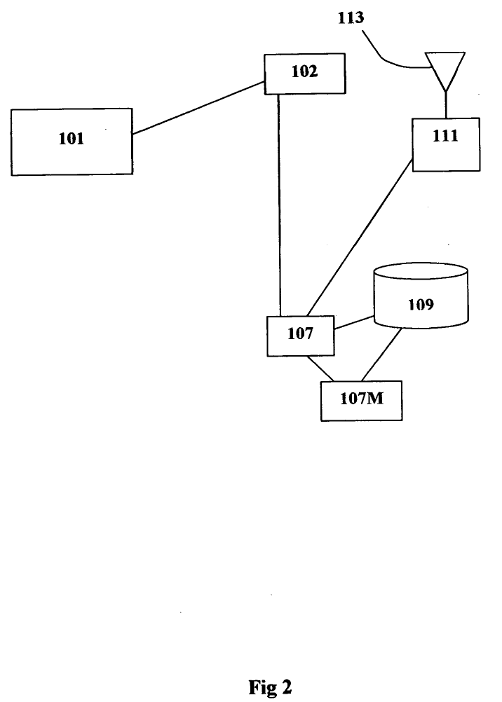

FIG. 2 shows an operator interface device for an on screen takeoff system incorporating typical areas functionality. The block diagram of FIG. 2 shows the block 101 operator interface with a video driver block 102 connected to processor 107 for data manipulation and number crunching with the storage 109 facilitating storing of costing databases, a memory block 107M, and a transceiver radio block 111 with an antenna 113. Although the network interface device is shown as a radio with antenna a hardwire network or similar configuration that connects the system to a network or world wide web type network is envisioned.

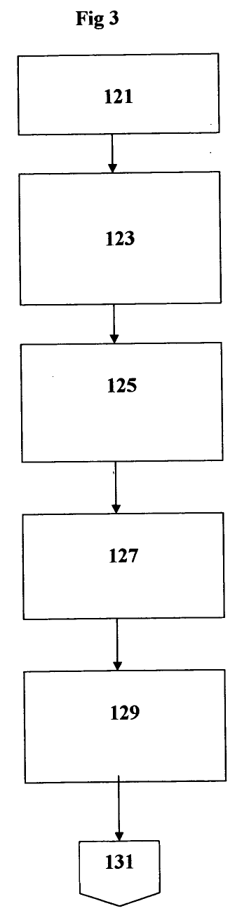

FIG. 3 shows a program flow for an on screen takeoff system incorporating typical areas functionality. The program flow starts with a start block 121 and a computer (desktop or laptop) with operating system loaded and an object digital file drawing (loaded through digital input or scanned in from a paper drawing) and the area for operation selected on the display. A next block 123 is where the operator sets the basic conditions, scale, rates, and other support conditions. A next block 125 is where the operator enters selections onto the operator interface by drawing lines on a screen to graphically input the items or tasks to be taken off the drawing. A next block 127 is where the system calculations are performed by the system software through a computer survey of quantities, values, and labor rates where formulas are applied and calculations performed to determine quantity takeoff information and translate these data into a collection of materials, labor, and costs. A next block 129 is where the calculation results are displayed to the operator on the operator interface. A next block is a connector directing the program flow to the next sheet. On the next sheet (sheet 4 of 18) a block 133 accepts the operator adjustments, inputs, or other operations necessary to complete the task of taking off the items in the job necessary to accomplish the task. A next block 135 finalizes all the inputs and formulates information for a report for the analysis, takeoff, and bid information. A final block 137 accomplishes storing the takeoff product of the selected tasks and conditions and facilitates the operator to print, submit, transmit, bid, or collaborate with as necessary. Additional project information as assembled above can be called up, started or merged for other uses as the operator requires by again following the above sequence.

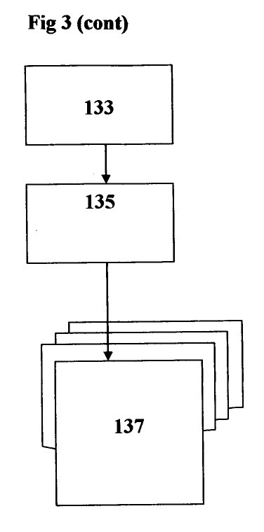

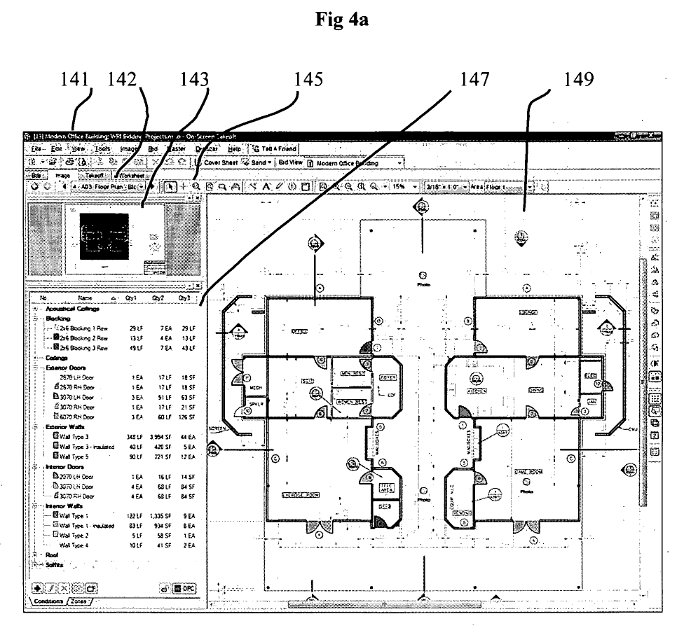

FIG. 4a shows a graphical screen presentation for an on screen takeoff system incorporating typical areas functionality. A typical working screen 141 is shown with a floor plan to be acted upon by an operator by identifying and taking off the features to be estimated to determining the materials, labor, and costs associated with job accomplishment. The screen 141 features lines, objects, and conditions values represented in both graphical and tabular format. An area 142 features tabbing controls for quick navigation to bids, images, takeoffs, and worksheets. An area 143 shows the floor plan reference drawing page. An area 145 provides a powerful tool bar for viewing and operating on a digital drawing floor plan displayed in an area 149. The image of the floor plan in area 149 can be loaded into the operators' computer as a digital file or scanned from a paper drawing plan set. The floor plan displayed in area 149 has interactive capabilities wherein an operator can draw directly on the screen to select, modify, or enter material and labor costing to determine a job costing for a specific floor plan. Specific lines, objects, and conditions represent plans for walls, electrical, plumbing, and doors. Depending on the display medium an operator may draw takeoff lines directly to a screen with a mouse, pen, voice, selector or other appropriate device to inform the processor 107 in FIG. 1 what feature (line, object, or condition) the operator desires to operate on. The computer through processor 107 will update the associated drawing lines, objects, and conditions and correlate the associated costing database with the operator input and determine a database value. Returning to FIG. 4a an area 147 shows a companion tabular format column collection of specifics and values contained in the floor plan along side the graphics in area 149 as taken off by the operator with specifications, sizes, and costs. The area 147 features a series of color coded items keyed to the left of each entry for ease of identity with area 149 graphics. An objects status properties are indicated on the area 149 by color coding with corresponding values and percentages shown in area 147. Default color coding schema are provided with samples shown in area 147.

FIG. 4b shows an on screen data sheet presentation for an on screen takeoff system incorporating typical areas functionality. A screen 161 shows the data presentation for an on screen takeoff system. An area 163 features tabbing controls for quick navigation to bids, images, takeoffs, and worksheets. A row 165 shows a heading for grouping of takeoff items such as interior walls, exterior walls, etc., rows are entered to separate items. A column 167 displays quantities and status of items to the right and color coding aides in identifying items on drawings. A column 169 displays the name of the item with status (when entered). A column 171 displays the height of the item. A column 173 displays the area and the corresponding quantity of the item. A column 175 displays the quantities and UOM's (units of measurements) of the item. A column 177 is an area for notes of installation operations.

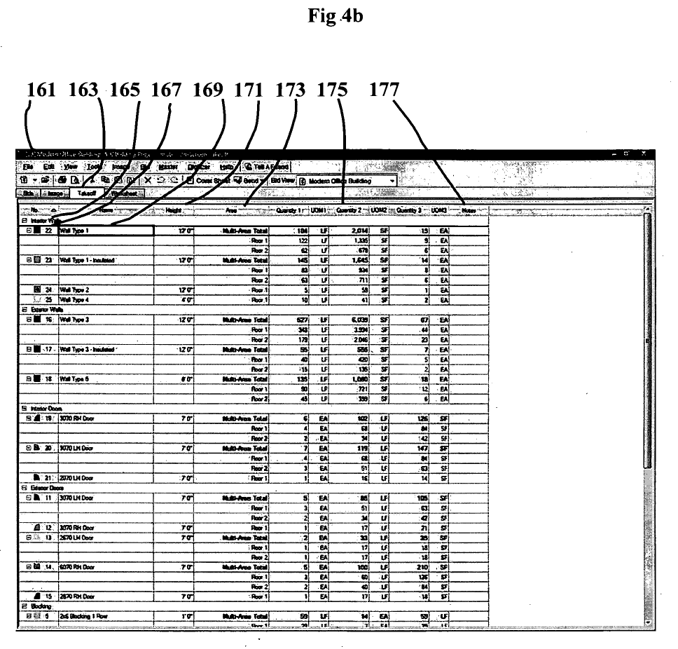

FIG. 5 shows a section of a screen with a calculation of an object to establish a condition for an on screen takeoff system incorporating typical areas functionality. A first graphic shows a digital drawing floor plan 181 that is a captured section from the floor plan of FIG. 4a. The floor plan 181 can now be set as a condition and the tabular data 183 will be also captured and is available for operator use and assignments and can be reused by the operator to capture similar areas more quickly.

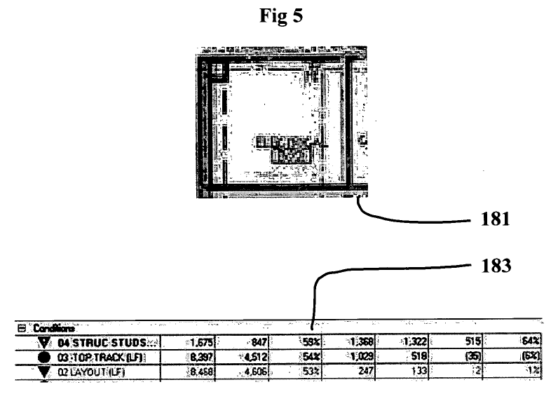

FIG. 6 shows a sample data type format for an on screen takeoff system incorporating typical areas functionality in industry standard data format. The schema utilized shown in a format sample 185 in digital production control data manipulation and database storage is extensible markup language (XML). These data handling and storage formats allow digital information interaction, exchange, and compatibility with most major software programs that are used by digital production control users. This standard data format facilitates project analysis, bidding, tracking, monitoring, and digital information exchange in an industry that demands extensive data interchange that is accessible and updatable.

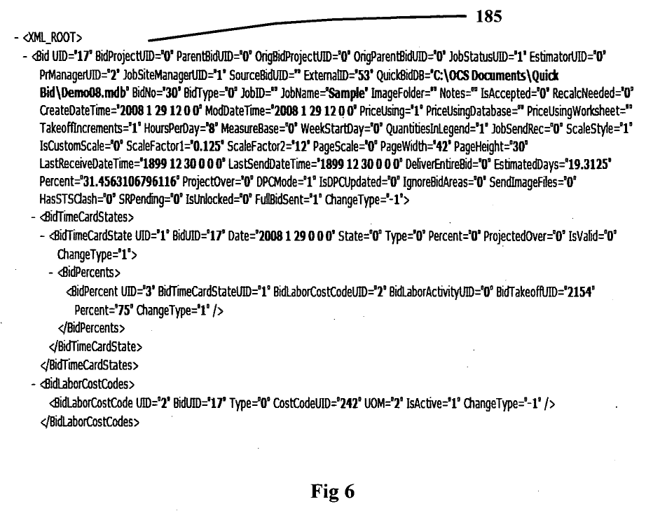

FIG. 7 shows an on screen technique for reusing established conditions in an on screen takeoff system incorporating typical areas functionality. A set of conditions 191 is shown and represents a block or set of conditions that can be reused by an operator to capture large areas and entire floors of some work sites. A collection of tabular data 193 is shown and is typical of the data that would accompany reusing entire collections of conditions.

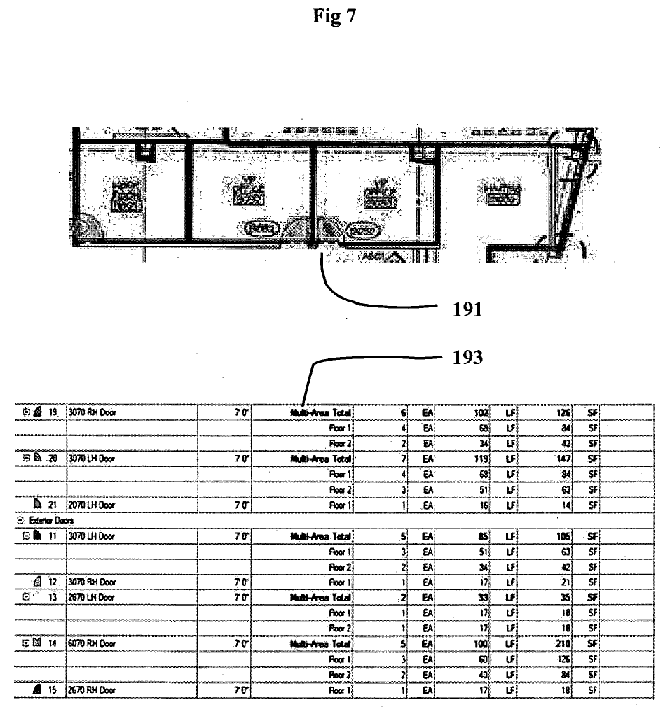

FIG. 8 shows an on screen technique for establishing a typical area condition in an on screen takeoff system incorporating typical areas functionality. An entire typical area 201 is shown for discussion. The area 201 can be reused, adjusted, modified or mirrored as needed for an operator to quickly complete a takeoff of a building with items such as repeated floors or wings. The tabular data set 203 is transferred with the typical area and will calculate the typical area conditions when reused.

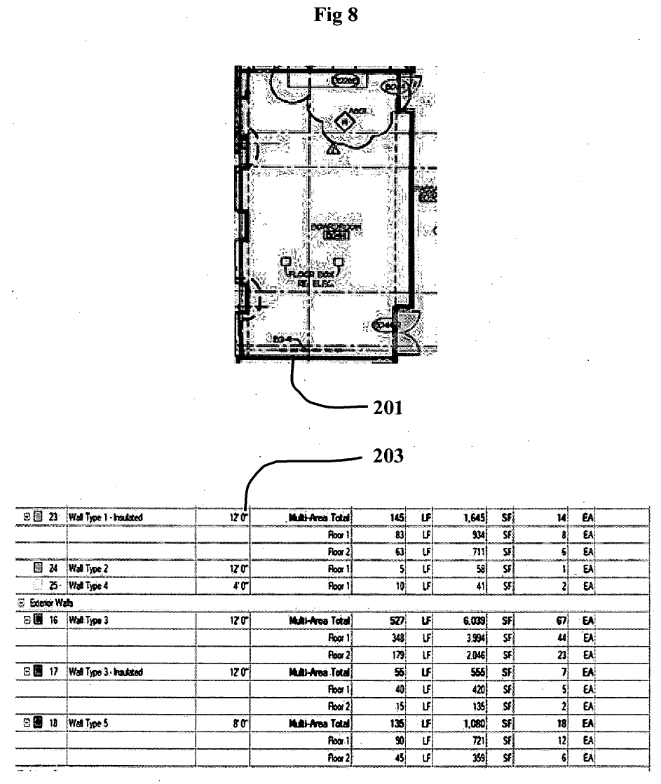

FIG. 9 shows a screen presentation of an image and conditions of a building with repeating floors for a typical area condition in an on screen takeoff system incorporating typical areas functionality. A computer product generated by processor 107 in FIG. 1 a screen 211 shown in FIG. 9. The screen 211 facilitates an operator speeding up the takeoff process by designating a typical area. The screen 211 has an image tab 213 selected in a tab area 215. A drawing plan title 217 designates the drawing area on the screen 211. A drawing plan navigation bar 219 informs the operator that the drawing plans have repeats for floors 8-29. Associated with the tab 213 is an image 221 which is a digital representation of the floor plan as designated in title 217, bar 219, and tab 213. A collection of navigation tools 223 and viewing aides 225 are included to improve operator viewing and operation. These tools 223 and aides 225 will assist the operator in navigation through drilling for information into the details and conditions of the drawing and takeoffs stored in the computer memory of data information values with simple point, click, and drag operations for information collection and interaction. A conditions side bar 227 is shown for operator reference and operation. As the present drawing plan has repeating floor the operator can perform the usual takeoff operation of drawing conditions on the screen on image 221 to engage the processor 107 (FIG. 1) to survey and calculate the quantities, materials, and time to estimate the time and costs to accomplish this task (for example installing walls, electrical, plumbing, finishing, and painting). Returning to FIG. 9 inputs are color coded on the image 221 to inform the operator that he has completed that condition and data values are updated and reflected in bar 227. An indicator box 229 has been drawn around plan A to initiate a typical area designation for identifying, storing, and reusing to improve operator efficiency. The operator can select this box 229 drawing area for specific operation(s).

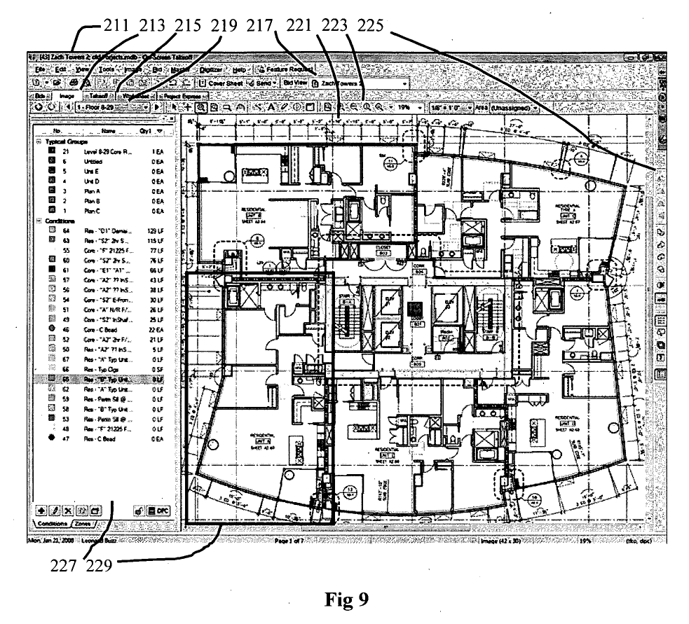

FIG. 10 shows a screen with a portion of the image and conditions of a building with repeating floors, as in FIG. 9, displayed for designation as a typical group. An operator selects a plan A by double clicking or tapping or other wise indicating to the processor 107 that this is the plan the operator wishes to operate on a computer generated screen 241 now shows the plan A (box 229) portion of the image from FIG. 9 isolated for operator interaction and viewing. The same basic navigation capabilities are available to the operator on FIG. 10 as in FIG. 9 (image tab 213, tab area 215, drawing title 217, bar 219 designation, image 221 area, tools 223 and aids 225). Returning to FIG. 10 the image 221 now displays plan A in image 243 for the operator condition designation. As the operator performs on screen takeoffs on plan A the updated conditions will be reflected in bar 227 for operator review and actions as necessary.

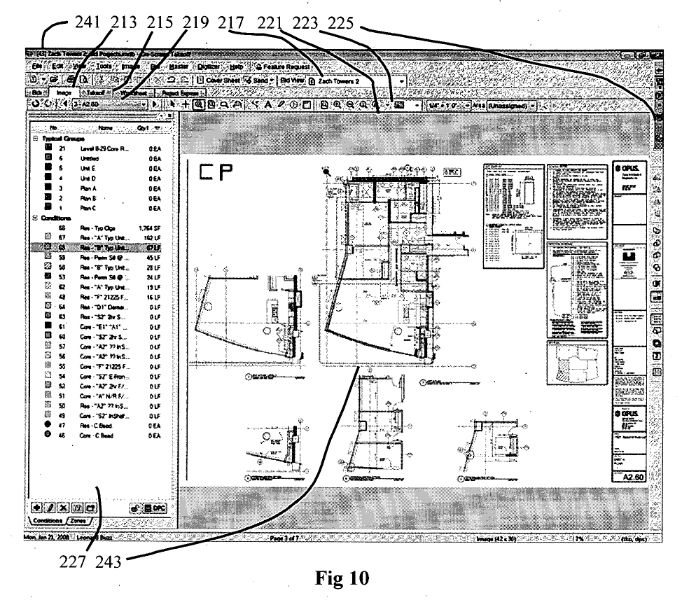

FIG. 11 shows a screen with a notice from the system processor instructing the operator on procedures to initiate designation of a typical group function. A computer generated screen 251 shows the plan A (box 229) portion of the image from FIG. 9 isolated for operator interaction and viewing containing a notification 253. The same basic navigation capabilities are available to the operator on FIG. 11 as in FIG. 9 (image tab 213, tab area 215, drawing title 217, bar 219 designation, image 221 area, tools 223 and aids 225). Returning to FIG. 11 the image 221 now displays plan A in image 221 with notification 253 instructing the operator to complete the typical area grouping by dragging a rectangle around the plan A in image 221. The conditions in bar 227 will show the established condition values before the instructions in notification 253 are completed.

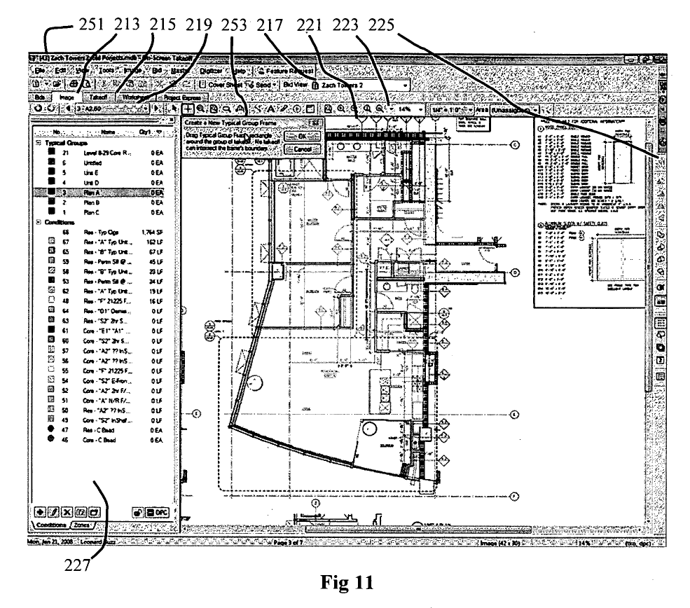

FIG. 12 shows a screen with a typical group designated. A computer generated screen 261 shows the plan A (box 229) portion of the image from FIG. 9 isolated for operator interaction and viewing containing a rectangle 263 surrounding plan A. The same basic navigation capabilities are available to the operator on FIG. 12 as in FIG. 9 (image tab 213, tab area 215, drawing title 217, bar 219 designation, image 221 area, tools 223 and aids 225). Returning to FIG. 12 the image 221 now displays plan A in image 221 with a set of conditions in bar 227 reflecting the typical area group bounded by rectangle 263. Specifically in rectangle 263, typical groups shows; 3, Plan A highlighted and conditions reflect the values of Plan A.

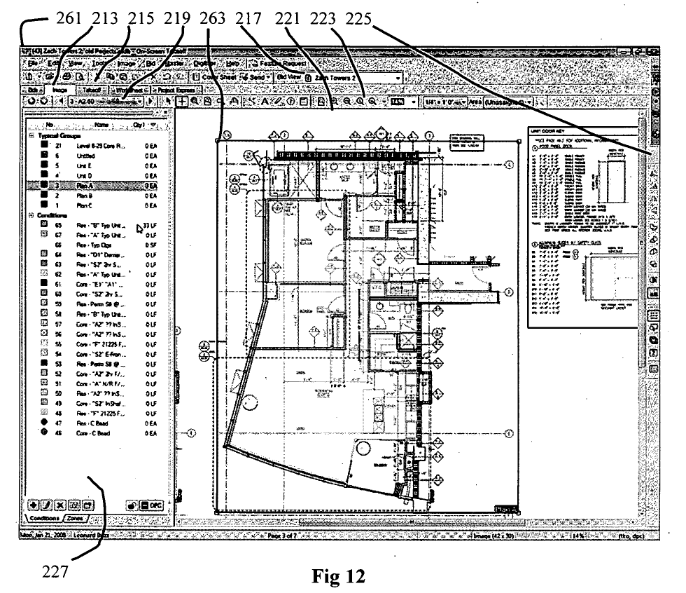

FIG. 13 shows a screen with a designated typical group combined into an entire floor. A computer generated screen 271 shows the plan A (box 229) portion of the image from FIG. 9 recombined with the other Plans on that floor for operator interaction and viewing. The same basic navigation capabilities are available to the operator on FIG. 13 as in FIG. 9 (image tab 213, tab area 215, drawing title 217, bar 219 designation, image 221 area, tools 223 and aids 225). Returning to FIG. 13 the image 221 now displays the entire typical group floor with plan A highlighted. The conditions bar 227 shows typical groups 3, Plan A highlighted and conditions reflect the values for the plan A typical group. Adjoining areas plan B, plan C, plan D, and plan E can be grouped similarly or in aggregate to adapt to the individual operator's preferences and the plans requirements.

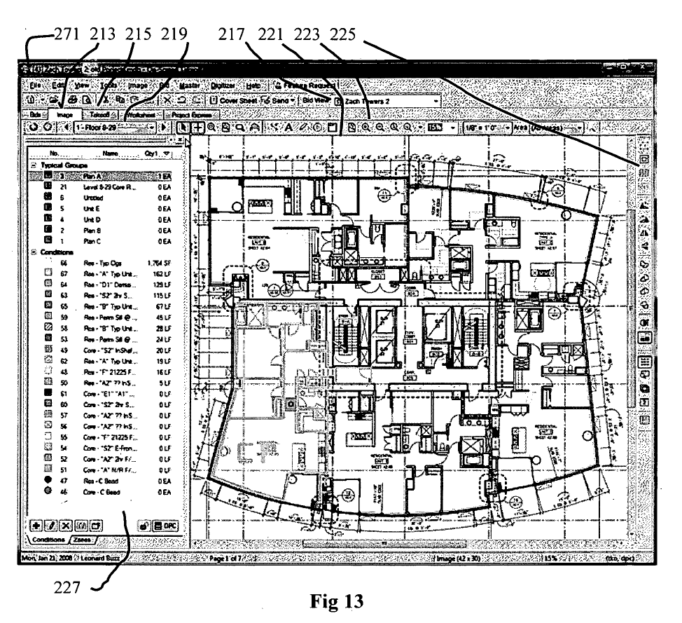

FIG. 14 shows a data screen with a designated typical group assigned to multiple floors. To coordinate operator takeoffs, bidding, and tracking a cover sheet screen 281 is shown for keeping track of plan drawing pages, preferences, and other functions. The screen 281 has a header area 283 for job status, bid number, project name, job number, estimator, notes, and control buttons; OK, Cancel, and Areas. The middle area of screen 281 allows the operator to select the costing data base for the job in the Price Using a drop down box 285. Along side box 285 is the location of the database selected. Operators can select the costing database desired or create a specific database as the project demands. A collection of 4 navigational tabs 289 is shown with pages selected. The operator may also select preferences, digital percent complete (DPC) or work crew for selection, monitoring, or bidding. A main display area of screen 281 presents an image 291 of pages with a diagonal heading featuring page title, repeats, page size, scale, image file (storage location) index, overlay image, and show (original, change, etc.). The displayed image 291 shows floor 8-29 with 5 repeats expanded with 5 sub entries. The floor 8-29 can be collapsed once the operator is familiar with the repeating floor minimizing the repeating data.

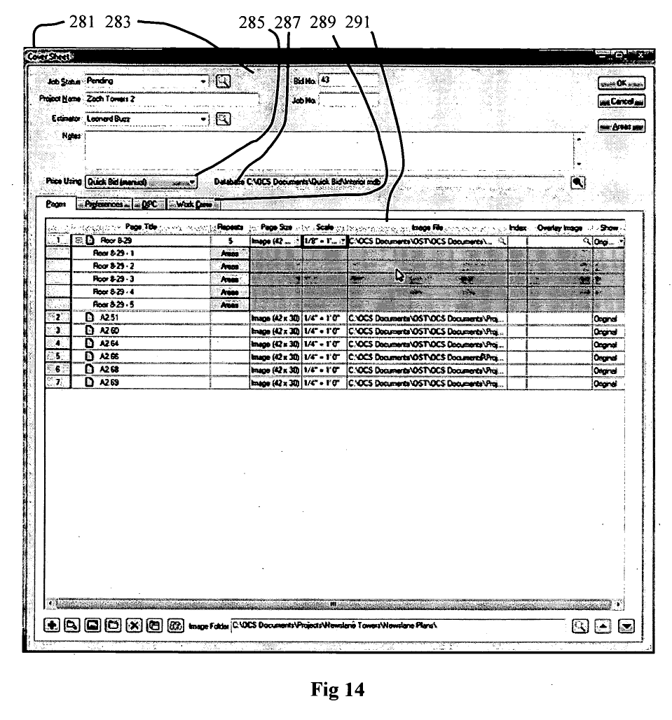

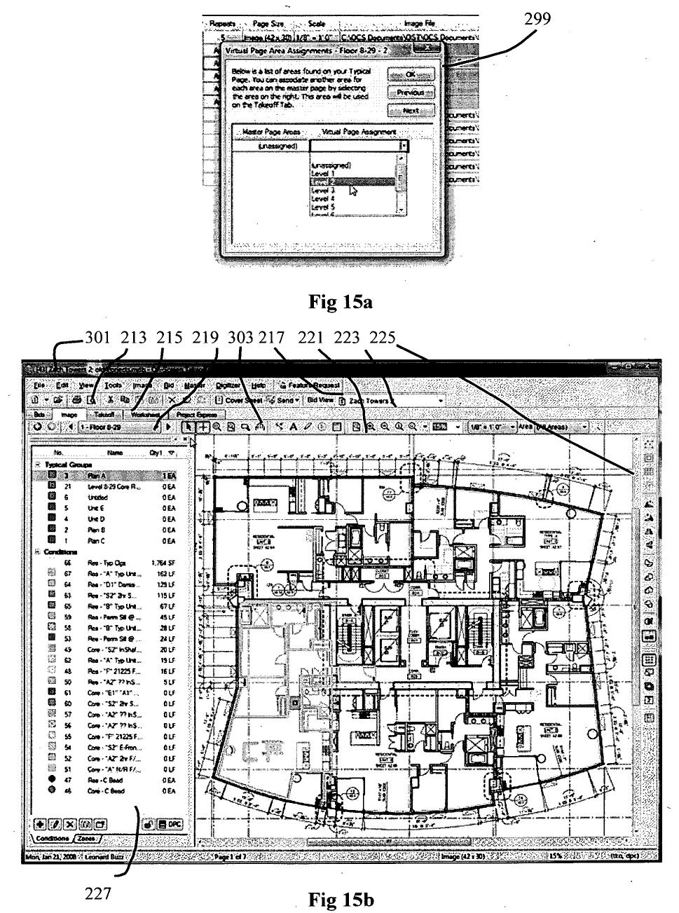

FIG. 15a shows a pop up screen with typical page association instructions for operators. The processor 107 from FIG. 1 will generate an announcement 299 as shown in FIG. 15a when virtual page area assignments are entered. An operator will be presented with a list of the levels assigned and can further associate another areas by selecting virtual pages with master pages. This functionality will assist the operator in maximizing grouping functionality.

FIG. 15b shows a screen with a typical page banner to inform the operator that grouping and associations have been incorporated. A computer generated screen 301 shows the plan A (box 229) portion of the image from FIG. 9 recombined with the other Plans on that floor for operator interaction and viewing. The same basic navigation capabilities are available to the operator on FIG. 13 as in FIG. 9 (image tab 213, tab area 215, drawing title 217, bar 219 designation, image 221 area, tools 223 and aids 225). Returning to FIG. 15b the image 221 now display a banner 303 reminding the operator that this typical page repeats 5 times and that totals shown are for a single page, additionally, the takeoff tab in area 215 reflects the totals for all typical pages. The conditions bar 227 reflects the typical groups 5, unit E and conditions reflect unit E takeoffs.

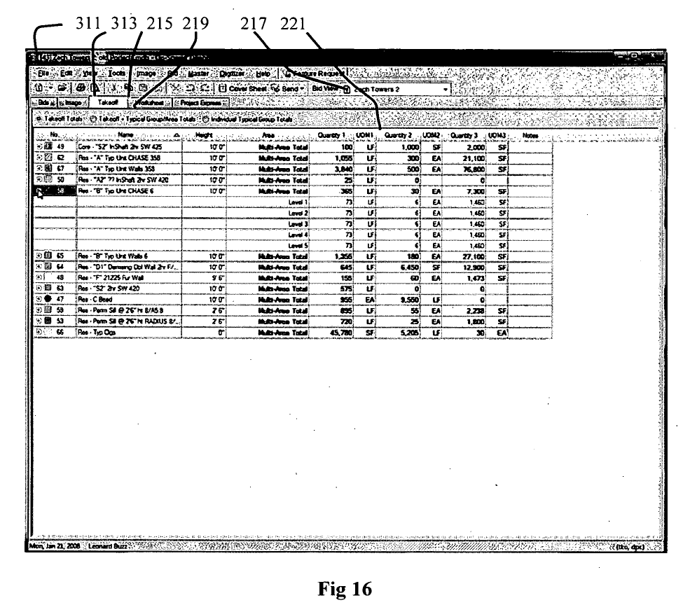

FIG. 16 shows a screen displaying repeated typical groups on repeated floors. A computer generated screen 311 shows the total values displayed when the takeoff tab in FIG. 15b is activated. Some of the basic navigation capabilities are available to the operator on FIG. 13 as in FIG. 9 (tab area 215, bar 219 designation (of takeoff tools), drawing title 217, image 221). Returning to FIG. 16 the tab area 215 has takeoff tab 313 selected and the image 221 now displays the takeoff totals for the entire groups and takeoffs.

Operation

An operator can simply initialize any windows compatible computer with the on screen takeoff systems software program (as discussed in FIG. 3) installed. A set of screen as shown in FIGS. 4a, 4b, and 5 will be available to the operator through the tabbing navigation area 142 as shown in FIG. 4a. The operator simply sets the desired conditions for installation rates and charges and proceeds to select the portions of the items for implementation. As items and areas are selected the program keeps track of the materials, labor, and costs to implement the selected items. Changes and adjustments can be accomplished through FIG. 7 and variations are discussed in FIGS. 8, 11, and 12.

### DESCRIPTION OF THE PREFERRED EMBODIMENT(S)

The preferred embodiment of an on screen takeoff is configured as shown in FIGS. 1 and 2. A program flow as discussed in FIG. 3 will enable an operator to quickly and easily eliminate manual summarization errors and view details, sections and elevations to capture the work to be done with materials, labor, and costs.

What is claimed is:

1. A computer system wherein an operator's analysis of a digital plan drawing is accomplished by an operator drawing on a computer screen with an image that is a graphical representation of a digital drawing plan to determine quantity takeoff information, measurements, and typical areas of the digital plan drawing for a construction project through a computer survey of an operator's drawing on the computer screen represents an input of lines, objects, and conditions where repeated assemblage of lines, objects, and conditions are collected by a computer processor by system software and stored in a computer memory as digital information in a project unique database for reuse based on the operator inputs consisting of:
a collection means of takeoff information database values are correlated in the computer memory by a computer processor to a graphical representation of the drawing information,
an information input means into the graphical representation of drawing information whereby the operator draws lines, objects, and conditions on the computer graphical screen display causing the computer processor to perform an update of the associated drawing lines, objects, and conditions database values and visual display or the digital drawing plan,
an association means through a series of colors associated with drawing lines, objects, and conditions on the graphical representation informing the operator of drawing lines, objects, or conditions type,
a database means values displayed the computer screen in tabular columns as a companion to the graphical representation of the line, object, and condition values,
a drawing navigation means supported by the computer processor on the computer screen facilitating the operators drilling for information details stored in the computer memory of data information values,
an operator's information input means through simple point, click, and drag to the computer through the screen for identifying, storing, and reusing stored information from the typical areas and;
takeoff information means stored in an industry standard data format facilitating project analysis, bidding, tracking, monitoring, and digital information exchange.

2. The computer system of claim 1 wherein the computer system is located in situ reducing costs for operators.

3. The computer system of claim 1 wherein operator drawing takeoffs on the image of the digital drawing represented on the computer screen includes a pen on tablet, a mouse on screen, a voice, and an operator input.

4. The computer system of claim 1 wherein takeoff information values (calculations, measurements, and counts) are accomplished by a in situ processor.

5. The computer system of claim 1 wherein the digital plan drawing can be loaded directly into the operator's computer or an image brought in from a scanned paper drawing plan.

6. The computer system of claim 1 wherein the computer processor performs the computer survey of quantities, values, and labor is based on an operators input and an associated stored costing database.

7. The computer system of claim 1 wherein the lines, objects, and conditions on a screen image represent plans for walls, electrical, plumbing, and doors.

8. The computer system of claim 1 wherein data information values stored in a computer memory are available for an operator's use and assignment(s).

9. The computer system of claim 1 wherein the object displayed in a digital image on a screen has status properties color coded for identification of a line, object, or conditions status.

10. The computer system of claim 1 wherein computer navigation into a digital drawing image by drilling into drawing details facilitates information collection and interaction.

11. The computer system of claim 1 wherein computer navigation of images is accomplished by point, click, and drag for operator image interaction and data manipulation.

12. The computer system of claim 1 wherein digital information exchange and manipulation is facilitated by industry standard data format.

13. A method for facilitating an operator's analysis of a digital plan drawing through an operator drawing on a computer screen with an image that is a graphical representation of a digital drawing plan loaded and stored within a computer with system software facilitating determination of quantity takeoff information, measurements, and typical areas of the digital plan drawing for a construction project through a computer survey of the operator(s) drawing on the computer screen representing an input of lines, objects, and conditions where repeated assemblage of lines, objects, and conditions are collected by a computer processor and stored in a computer memory as digital information in a project unique database for reuse based on the operator inputs consisting of:
collecting of takeoff information database values which are correlated in the computer memory by a computer processor to a graphical representation of the drawing information through a screen image,
inputting information into the graphical representation of drawing information in the image whereby the operator draws lines on the computer graphical screen display causing the computer to update the associated drawing lines, objects, and conditions database values,
associating a series of colors with drawing lines, objects, and conditions on the graphical representation informing the operator of drawing lines, objects, or conditions type,
displaying a database's values on a computer screen in tabular columns as a companion to the graphical representation of the line, object, and condition values,
implementing a drawing navigation schema through a computer processor on a computer screen facilitating the operators drilling for information details stored in the computer memory of information values,
inputting from an operator's information input through simple point, click, and drag to the computer through the screen for identifying, storing, and reusing stored information from the typical areas and;
storing takeoff information in an industry standard data format facilitating project bidding tracking, monitoring, and digital information exchange.

14. The method for facilitating an operator drawing on a computer screen to determine quantity takeoff information and typical areas of a digital plan drawing for a construction project according to claim 13 wherein an operator drawing on a screen can be by pen on tablet, mouse, voice, and operator input.

15. The method for facilitating an operator drawing on a computer screen to determine quantity takeoff information and typical areas of a digital plan drawing for a construction project according to claim 13 wherein hosting system software on an in situ processor facilitates operator efficiency and productivity.

16. The method for facilitating an operator drawing on a computer screen to determine quantity takeoff information and typical areas of a digital plan drawing for a construction project according to claim 13 wherein determining digital plan takeoff information values (calculations, measurements, and counts) is accomplished from the operator input by a processor association with a data base.

17. The method for facilitating an operator drawing on a computer screen to determine quantity takeoff information and typical areas of a digital plan drawing for a construction project according to claim 13 wherein loading of digital plan drawings directly into the operator's computer or scanned from a paper drawing plan is facilitated.

18. The method for facilitating an operator drawing on a computer screen to determine quantity takeoff information and typical areas of a digital plan drawing for a construction project according to claim 13 wherein performing a computer survey by a processor for collection, operation, and storage of takeoff information is provided.

19. The method for facilitating an operator drawing on a computer screen to determine quantity takeoff information and typical areas of a digital plan drawing for a construction project according to claim 13 wherein representing lines, objects, and conditions values in graphical and tabular form is facilitated.

20. The method for facilitating an operator drawing on a computer screen to determine quantity takeoff information and typical areas of a digital plan drawing for a construction project according to claim 13 wherein storing lines, objects, and conditions values in a computer memory is provided.

21. The method for facilitating an operator drawing on a computer screen to determine quantity takeoff information and typical areas of a digital plan drawing for a construction project according to claim 13 wherein indicating object status on drawing images by color coding is facilitated.

22. The method for facilitating an operator drawing on a computer screen to determine quantity takeoff information and typical areas of a digital plan drawing for a construction project according to claim 13 wherein navigating for data information is available to an operator through drilling into images associated with databases.

23. The method for facilitating an operator drawing on a computer screen to determine quantity takeoff information and typical areas of a digital plan drawing for a construction project according to claim 13 wherein simple navigating by point, click, and drag operations allows an operator to input, update, and review a project.

24. The method for facilitating an operator drawing on a computer screen to determine quantity takeoff information and typical areas of a digital plan drawing for a construction project according to claim 13 wherein exchanging digital information is facilitated in an industry standard format.

25. A computer product enabling an operator drawing on a computer screen for determining quantity takeoff information and typical areas of digital plan drawing for a construction project through a computer survey of an operator's input of lines, objects, and conditions where repeated assemblage of lines, objects, and conditions are collected and stored in a computer memory for reuse based on the operator's inputs to a collection of computer screens, interface means, storage means, processor means, navigation means, and database association means wherein the computer products information, images, and reports reduce operator effort and time to analyze, takeoff, and bid construction projects.
